(19) United States
(12) Patent Application Publication
(10) Pub. No.: US 2026/0103066 A1
(43) Pub. Date: Apr. 16, 2026

(54) Off-Road Vehicle

(71) Applicant: Zhejiang CFMOTO Power Co., Ltd., Hangzhou (CN)

(72) Inventors: Meilin Feng, Hangzhou (CN); Wanru Liu, Hangzhou (CN); Yunqiang Huang, Hangzhou (CN); Longping Luo, Hangzhou (CN); Tiankai Gao, Hangzhou (CN)

(21) Appl. No.: 19/254,229

(22) Filed: Jun. 30, 2025

(30) Foreign Application Priority Data
Aug. 21, 2024 (CN) 202411155109.2
Aug. 28, 2024 (CN) 202411187986.8

(51) Int. Cl. B60K 11/04; B60K 11/08; B60K 13/02

(52) U.S. Cl. CPC B60K 11/04; B60K 11/08; B60K 13/02; B60Y 2200/20

(57) ABSTRACT

An all-terrain vehicle includes a frame, a vehicle cover, a plurality of wheels, a prime mover assembly, and a radiator assembly. The radiator assembly includes a radiator positioned on a pivotable radiator bracket at least partially above a front cover plate of the vehicle cover. The radiator bracket can be secured with the radiator in a standard operating position at least partially above at least some of the electrical assembly. The radiator bracket can be pivoted between the standard operating position of the radiator, a high performance position in the range from 12° to 36° higher, and a maintenance position to facilitate access to the at least some of the electrical assembly.

### RELATED APPLICATION INFORMATION

The present application claims the benefits of priority to Chinese Patent Application No. 202411155109.2, filed with the Chinese Patent Office on Aug. 21, 2024, and Chinese Patent Application No. 202411187986.8, filed with the Chinese Patent Office on Aug. 28, 2024. The entire contents of the above-referenced applications are incorporated herein by reference.

### FIELD OF THE DISCLOSURE

The present application relates to the field of vehicles, and particularly to an all-terrain vehicle.

### BACKGROUND OF THE DISCLOSURE

An all-terrain vehicle is a type of vehicle that can travel on a wide variety of terrains. When an all-terrain vehicle passes through muddy roads, trails and bogs, mud and other debris can stick to and accumulated on the all-terrain vehicle. A radiator of an all-terrain vehicle is mainly used to dissipate heat from the engine. If the radiator is not maintained and timely cleaned when it is splattered or coated by mud, the heat dissipation performance of the radiator will be reduced, which results in poor engine efficiency and can result in overheating. In existing all-terrain vehicles, the radiator is generally fixed at an inconvenient location. When the radiator needs to be cleaned, maintained, disassembled and/or repaired, the maintenance process can be quite complicated.

### SUMMARY OF THE INVENTION

In order to address the shortcomings of existing vehicles, the purpose of this application is to provide an all-terrain vehicle with a radiator that operates efficiently.

The present invention provides an all-terrain vehicle which includes a frame, a vehicle cover, a plurality of wheels, a prime mover assembly, and a radiator assembly. The frame includes a main frame and a protective front guard positioned at least partially forward of the main frame. The vehicle cover includes a front cover plate positioned at least partially above the main frame. The plurality of wheels support the main frame. The prime mover assembly is supported by the main frame and coupled to at least some of the plurality of wheels for locomotion of the all-terrain vehicle. The radiator assembly is positioned at least partially above the front cover plate and includes a radiator for dissipating heat from the prime mover assembly.

In one aspect, the all-terrain vehicle further includes an electrical assembly supported by the frame. The frame further includes a radiator bracket pivotally supporting the radiator assembly. The radiator bracket can be secured with the radiator in a standard operating position at least partially above at least some of the electrical assembly. The radiator bracket can be pivoted between the standard operating position and a maintenance position thereby moving the radiator to facilitate access to the at least some of the electrical assembly.

In another aspect, the frame further includes a radiator bracket supporting the radiator. The radiator bracket can be secured with the radiator in a standard operating position or can be secured with the radiator in a high performance position. The radiator defines a radiator plane which is at a radiator angle to horizontal. The radiator angle is from 12° to 36° higher when in the high performance position than when in the standard operating position.

In yet another aspect, the protective front guard includes an upper bar exposed above the front cover plate. The upper bar is pivotably attached relative to the main frame. The upper bar can be secured relative to the main frame with the radiator in a standard operating position. The upper bar can be pivoted to move the radiator between the standard operating position and a maintenance position.

The radiator of the above all-terrain vehicle can thus be easily moved between different positions, thereby improving the working efficiency of the radiator.

### BRIEF DESCRIPTION OF THE DRAWINGS

FIG. 1 is a left side view of an all-terrain vehicle in accordance with a preferred embodiment of the present invention;

FIG. 2 is a front view of the all-terrain vehicle of FIG. 1;

FIG. 3 is a right side view of the all-terrain vehicle of FIGS. 1 and 2, with a central portion of the vehicle cover broken away so the positioning of the prime mover assembly and cooling air ducts can be better seen;

FIG. 4 is a top plan view of the all-terrain vehicle of FIGS. 1-3, with a central portion of the vehicle cover broken away so the positioning of the prime mover assembly and cooling air ducts can be better seen;

FIG. 5 is a front view of the air ducts and air filter of the all-terrain vehicle of FIGS. 1-4;

FIG. 6 is a front left perspective view of the prime mover assembly and cooling air ducts of the all-terrain vehicle of FIGS. 1-4 (omitting in particular the air filter duct and air filter for clearer viewing);

FIG. 7 is a top plan view of the prime mover assembly of FIGS. 3-6 and air filter of FIGS. 4 and 5, with an alternative arrangement of air ducts;

FIG. 8 is a slightly elevated rear perspective view with portions of the vehicle cover broken away to better show positioning of the air ducts in the alternative arrangement of FIG. 7;

FIG. 9 is a slightly elevated rear perspective partial view of other select portions to better show positioning of the air filter duct in the alternative arrangement of FIGS. 7 and 8 relative to the instrument panel;

FIG. 10 is a schematic rear view of another alternative arrangement of air ducts;

FIG. 11 is a left side view of the all-terrain vehicle of FIGS. 1-4 with a driver in an aggressive riding posture on flat ground;

FIG. 12 is an enlargement of portion 12 of FIG. 11;

FIG. 13 is a left side view of the all-terrain vehicle of FIGS. 1-4 and 11 with a driver in an aggressive riding posture at the water wheelie balance point;

FIG. 14 is a top plan view of the protective front guard, radiator bracket and select portions of the main frame of the all-terrain vehicle of FIGS. 1-4, 11 and 13;

FIG. 15 is a left side view of the upper bar of the protective front guard, the radiator bracket and radiator, select parts of the electrical assembly and select portion of the main frame of the all-terrain vehicle of FIGS. 1-4, 11 and 13, with the radiator bracket and radiator in the standard operating position;

FIG. 16 is a left side view of the structures of FIG. 15 in the high performance position;

FIG. 17 is a left side view of the structures of FIG. 15 in the maintenance position;

FIG. 18 is a schematic side view of a radiator in the standard operating, high performance and maintenance positions;

FIG. 19 is a top plan view of the all-terrain vehicle of FIGS. 1-4, 11, 13 and 14 with the radiator bracket in the maintenance position;

FIG. 20 is a left side view of an alternative upper bar and radiator bracket holding a radiator, which can be used with the all-terrain vehicle of FIGS. 1-4, 11, 13 and 14;

FIG. 21 is a left side view of the alternative upper bar of FIG. 20 with a second alternative radiator bracket holding a radiator, which can be used with the all-terrain vehicle of FIGS. 1-4, 11, 13 and 14;

FIG. 22 is a left side view of an alternative all-terrain vehicle with a pivotable upper bar which has been swung forward to the maintenance position for the radiator assembly;

FIG. 23 is a front left perspective view of the radiator assembly of the all-terrain vehicle of FIGS. 1-4, 11, 13, 14 and 19;

FIG. 24 is an exploded perspective view of the radiator assembly of FIG. 23; and

FIG. 25 is a left side view of the all-terrain vehicle of FIGS. 1-4, 11, 13, 14, 19 and 23 with the wheels drawn schematically to better show certain frame and winch parts.

While the above-identified drawing figures set forth preferred embodiments, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

For better understanding of the above objects, features and advantages of the present invention, embodiments of the present disclosure will be described in detail below with reference to the accompanying drawings.

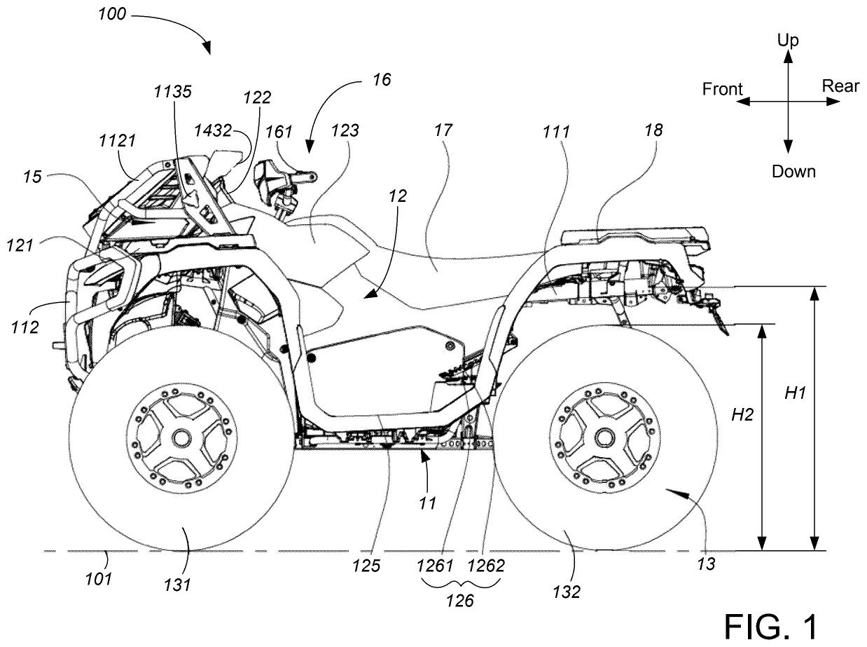

As shown in FIGS. 1-4, an all-terrain vehicle 100 includes a frame 11, a vehicle cover 12, a plurality of wheels 13, a prime mover assembly 14, a radiator assembly 15, a steering assembly 16 with a steering handlebar 161, a saddle 17 and a cargo rack or box 18. The frame 11 serves as a basic structural support of the off-road vehicle 100 for carrying components of the all-terrain vehicle 100. The vehicle cover 12 is positioned at least partially on the frame 11, and is used to protect the internal components of the all-terrain vehicle 100. The vehicle cover 12 mainly refers to plastic or sheet metal parts of the all-terrain vehicle 100. The plurality of wheels 13 are positioned at least partially below the frame 11, and preferably include two front wheels 131 positioned toward the front of the all-terrain vehicle 100 and two rear wheels 132 positioned toward the rear of the all-terrain vehicle 100. The prime mover assembly 14 is used to provide power to the front wheels 131 and/or the rear wheels 132 to drive the all-terrain vehicle 100 to move, i.e., for locomotion of the all-terrain vehicle 100. The radiator assembly 15 is secured to the frame 11 and used to help cool the prime mover assembly 14. The steering assembly 16 is used to turn the front wheels 131 for steering of the all-terrain vehicle 100. The saddle 17 is used for an operator to straddle and sit on when driving the all-terrain vehicle 100. The cargo rack/box 18 is positioned rearward of the saddle 17 and used for carrying cargo and/or objects. As used herein, the length direction in embodiments of the application refers to a front-rear direction of the all-terrain vehicle 100, the width direction refers to a left-right direction of the all-terrain vehicle 100, and the height direction refers to the up-down direction of the all-terrain vehicle 100, all when the wheels 13 are positioned on level ground. For better understanding the technical solution of the present application, the directions of front, rear, up, down, left and right are called out in various drawings.

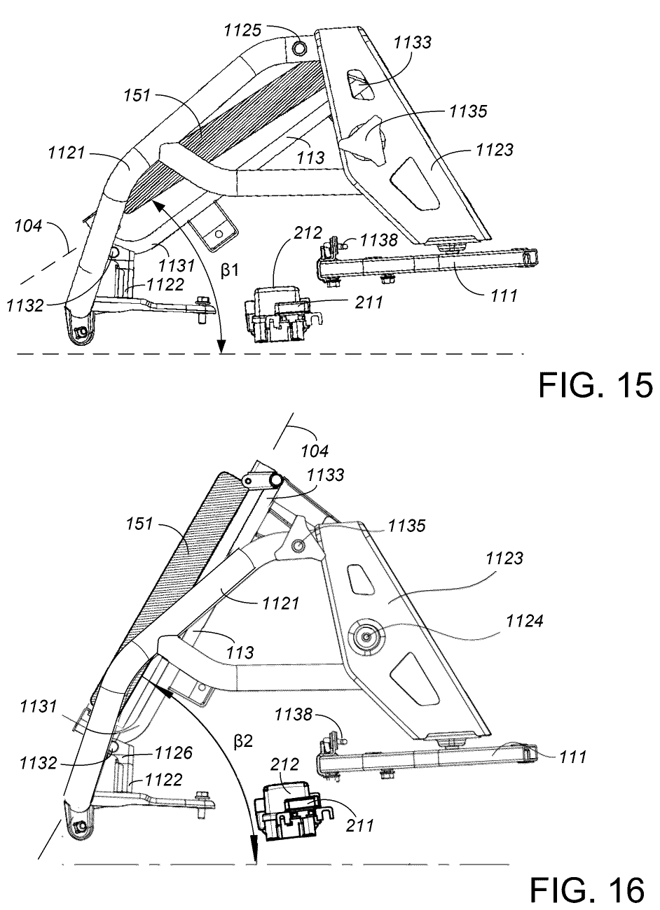

As shown in FIG. 1, the radiator assembly 15 is positioned at the front of the all-terrain vehicle 100 and relatively high in the all-terrain vehicle 100. The radiator assembly 15 includes a radiator 151 (called out in FIGS. 15-18, 20, 21 and 24). As shown in FIG. 3, the prime mover assembly 14 includes an internal combustion engine 141 and a transmission 142, with the engine 141 positioned at a relatively low, central location on the all-terrain vehicle 100 such as at least partially below the saddle 17. Positioning the engine 141 at a low, central location improves the center of balance of the all-terrain vehicle 100, reducing the likelihood of vehicle tipping. As known in the field, the radiator 151 and the engine 141 are connected through outgoing and return coolant lines (not shown). The system pumps coolant in a circuit so that heat generated by operation of the engine 141 is transferred to the radiator 151 through coolant flow, and then cooled by outside air against the radiator 151. In many existing all-terrain vehicles, the radiator is vertically arranged adjacent a front of the all-terrain vehicle to create maximum windward area, which facilitates the heat dissipation. However, this traditional arrangement can reduce the wading performance of the prior art all-terrain vehicle, making the radiator prone to malfunction due to sediment accumulation when driving in muddy and wading conditions.

In the preferred embodiment, the vehicle cover 12 includes one or more front cover plate(s) 121 positioned at the front of the all-terrain vehicle 100, extending higher than the front wheels 131 and forward of the steering handlebar 161. In order to ensure the all-terrain vehicle 100 can traverse deep mud and/or wading conditions, the radiator assembly 15 is at least partially positioned higher than the front cover plate(s) 121 and forward of the steering handlebar 161. When the all-terrain vehicle 100 traverses deep mud and/or wading conditions, the high position of the radiator 151 reduces risk of mud blockage, thereby improving the trafficability of the all-terrain vehicle 100 through deep mud and/or water. The vehicle cover 12 further includes an instrument panel 122 for displaying status and driving information of the all-terrain vehicle 100. The instrument panel 122 is positioned at least partially forward of the steering handlebar 161 and higher than the front cover plate(s) 121, and the radiator assembly 15 is preferably positioned at least partially forward of the instrument panel 122.

The saddle 17 is positioned at least partially above the engine 141 and the transmission 142, and the cargo rack/box 18 is positioned behind the saddle 17. The cargo rack/box 18 is fixedly connected to the frame 11, at the top of the frame 11. A plane defined by the bottoms of the wheels 13 while the all-terrain vehicle 100 is stationary is defined as a ground plane 101 as called out in FIG. 1. The cargo rack/box 18 has a cargo rack/box height H1 above the ground plane 101, defined at the lowest point of the cargo rack/box 18. The rear wheels 132 have a rear wheel height H2. A cargo height ratio H1/H2 of cargo rack/box height H1 to rear wheel height H2 is preferably in the range from 0.95 to 1.4, and most preferably 1.1. These values for cargo height ratio H1/H2 help to avoid water from entering into the cargo rack/box 18. Additionally, several electrical components (not shown) may be installed near the cargo rack/box 18. Increasing the cargo rack/box height H1 can further improve the water wading height of the all-terrain vehicle 100 without submersing such components. Further yet, the driver can also shift his or her center of gravity rearwardly by sitting on the cargo rack/box 18 during the driving process, which adds flexibility to the driver's control of the all-terrain vehicle 100.

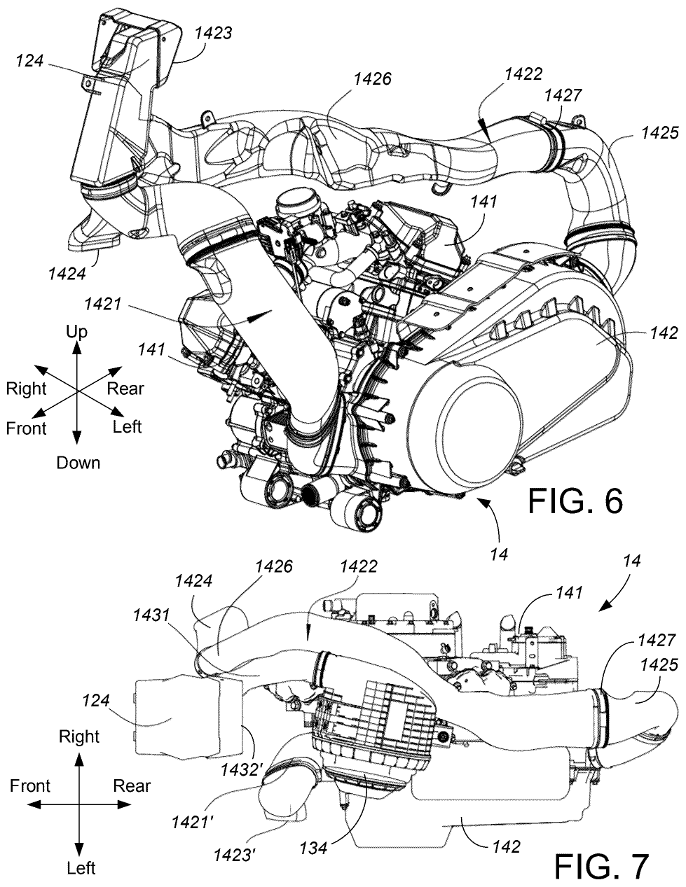

The transmission 142 is coupled to the engine 141 to change the speed of the engine 141, increase or decrease the torque of the engine 141, and enable the all-terrain vehicle 100 to obtain a more suitable power output mode for the usage scenario. The transmission 142 is preferably a continuously variable transmission (“CVT”) as known in the art, and CVTs generate heat during operation. The CVT 142 performs better, including having a longer service life and with less slippage, if cooled and kept dry. As better shown in FIGS. 3-6, the all-terrain vehicle 100 includes a cooling air intake duct 1421 and a cooling air outlet duct 1422 to circulate air for heat dissipation from the CVT 142. In the preferred embodiments, the cooling air intake duct 1421 delivers fresh air to the front of the CVT 142, while the cooling air outlet duct 1422 receives air from the rear of the CVT 142. The cooling air intake duct 1421 has a cooling air inlet 1423, and the cooling air outlet duct 1422 has a cooling air outlet 1424. In preferred embodiments, the cooling air inlet 1423 and the cooling air outlet 1424 are positioned rearward of the radiator assembly 15, and more preferably at least partially rearward of the instrument panel 122, near the steering handlebar 161. In the preferred configuration, the cooling air inlet 1423 faces mostly rearwardly, while the cooling air outlet 1424 faces mostly downwardly. Both the cooling air inlet 1423 and the cooling air outlet 1424 are at elevations which are higher than the top of the engine 141 and CVT 142. This high positioning of the cooling air inlet 1423 and the cooling air outlet 1424 minimizes the risk of mud or water entering either the cooling air inlet 1423 or the cooling air outlet 1424 and causing slippage or damage to the CVT 142 when the all-terrain vehicle 100 traverses deep mud or water conditions, improving the trafficability of the all-terrain vehicle 100.

The preferred cooling air outlet duct 1422 transports air output from the CVT 142 forwardly over a substantial horizontal distance. The preferred cooling air outlet duct 1422 includes a first outlet duct segment 1425 which extends from a rear end of the CVT 142 upwardly and then curving forwardly, and a separate second outlet duct segment 1426 that extends forwardly in a substantially horizontal length to a position where the cooling air outlet 1424 is further forward than the front of the CVT 142. The first outlet duct segment 1425 and the second outlet duct segment 1426 are joined at an outlet duct mid-junction 1427 that may include a hose clamp. The first outlet duct segment 1425 is preferably formed of a different material than the second outlet duct segment 1426, such as a material that is harder or more resistant to heat.

With the cooling air outlet duct 1422 transporting air over a substantial distance, the cooling air intake duct 1421 is preferably shorter and more direct than the cooling air outlet duct 1422. The preferred prime mover assembly orientation in the all terrain vehicle 100 places the CVT 142 on the left of the engine 141. The preferred orientation of the cooling air intake duct 1421 matches this CVT orientation, i.e., the cooling air intake duct 1421 is preferably positioned more to the left in the all terrain vehicle 100 than the cooling air outlet duct 1422. The cooling air outlet duct 1422 thus shifts the air rightwardly and extends largely horizontally over the top of the engine 141, with the airflow therein moving forwardly and slightly upwardly over the top of the engine 141. Some other embodiments are left to right mirror images of the depicted embodiment.

As already noted, the cooling air outlet 1424 in this embodiment faces substantially downwardly. By having the cooling air outlet 1424 face downwardly, and mud and/or water that splashes up into the cooling air outlet 1424 is more likely to gravitationally fall back out of the cooling air outlet 1424 than flow through the cooling air outlet duct 1422, against the airflow therein, to reach the CVT 142. The vehicle cover 12 includes a main cover 123 for covering the prime mover assembly 14, with at least a portion 1231 (called out in FIG. 3) of the main cover 123 extending between the steering assembly 16 and the instrument panel 122. The cooling air inlet 1423 is positioned at least partially outside and above this portion 1231 of the main cover 123, and the cooling air outlet 1424 is positioned inside and below this portion of the main cover 123. Use of the main cover 123 between the cooling air inlet 1423 and the cooling air outlet 1424 helps to separate the two air flows and avoids the higher temperature air leaving the cooling air outlet 1424 from being recirculated through the cooling air inlet 1423. In addition to facing downwardly, the cooling air outlet 1424 faces slightly outwardly and forwardly, helping to expel heat from the interior of the main cover 123. In the preferred embodiment, the cooling air inlet 1423 is further separated from the cooling air outlet 1424 by having the cooling air inlet 1423 positioned above the instrument panel 122.

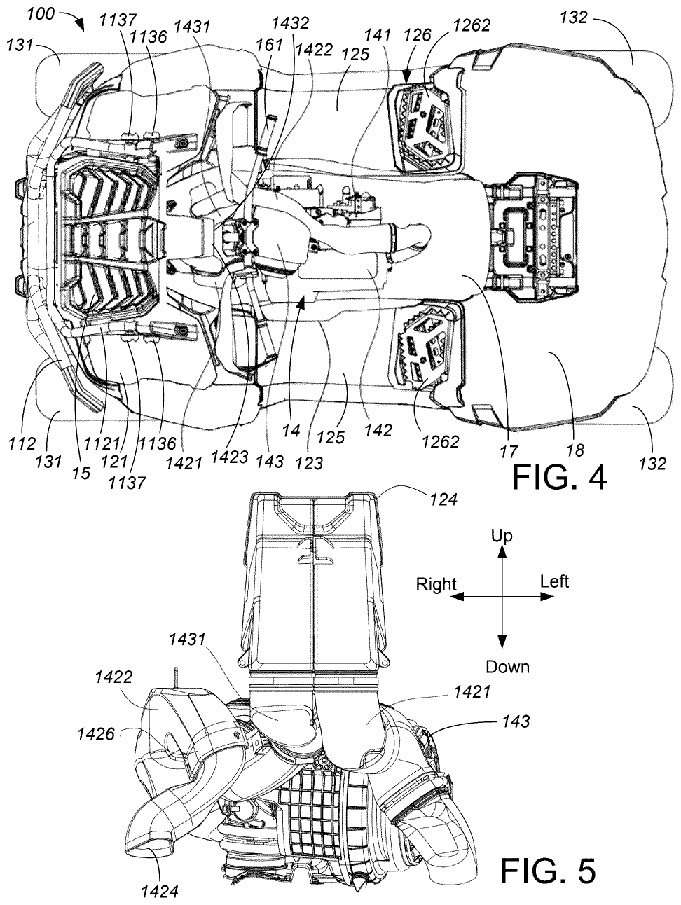

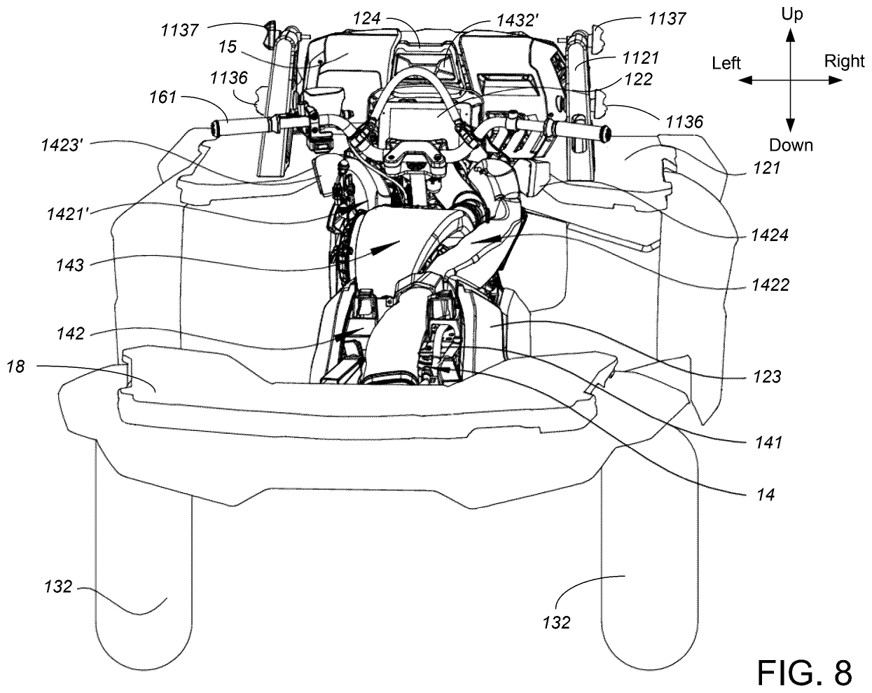

As best shown in FIGS. 4, 5, 7 and 8, the all-terrain vehicle 100 further includes an air filter 143 at least partially positioned above the engine 141. The air filter 143 is mainly used to filter air for combustion within the engine 141. The air filter 143 includes an air filter intake duct 1431 having a combustion air inlet 1432. The combustion air inlet 1432 is preferably positioned at least partially above the instrument panel 122 and at least partially forward of the steering handlebar 161 between the radiator assembly 15 and the steering handlebar 161, facing rearwardly. That is to say, the combustion air inlet 1432 faces substantially towards the steering assembly 16. This high positioning of the combustion air inlet 1432 helps avoid damage to the engine 141 by water entering the combustion air inlet 1432 when the all-terrain vehicle 100 traverses deep mud and/or water conditions. This not only improves the trafficability of the all-terrain vehicle 100 traversing mud and/or water conditions, but increases the service life of the air filter 143 and reduces the likelihood of engine stalling, thereby improving the safety of the all-terrain vehicle 100.

In the embodiment of FIGS. 4 and 5, the combustion air inlet 1432 is immediately adjacent and to the right of the cooling air inlet 1423 in the same plastic part 124, and the air filter intake duct 1431 initially runs vertically immediately adjacent and to the right of the cooling air intake duct 1421. This positions the air filter intake duct 1431 between the cooling air intake duct 1421 and the cooling air outlet duct 1422. The positioning of the combustion air inlet 1432 and the cooling air inlet 1423 both next to each other facing rearwardly and above the instrument panel 122 is very conducive to preventing mud or water from splashing into either the air filter intake duct 1431 or the cooling air intake duct 1421.

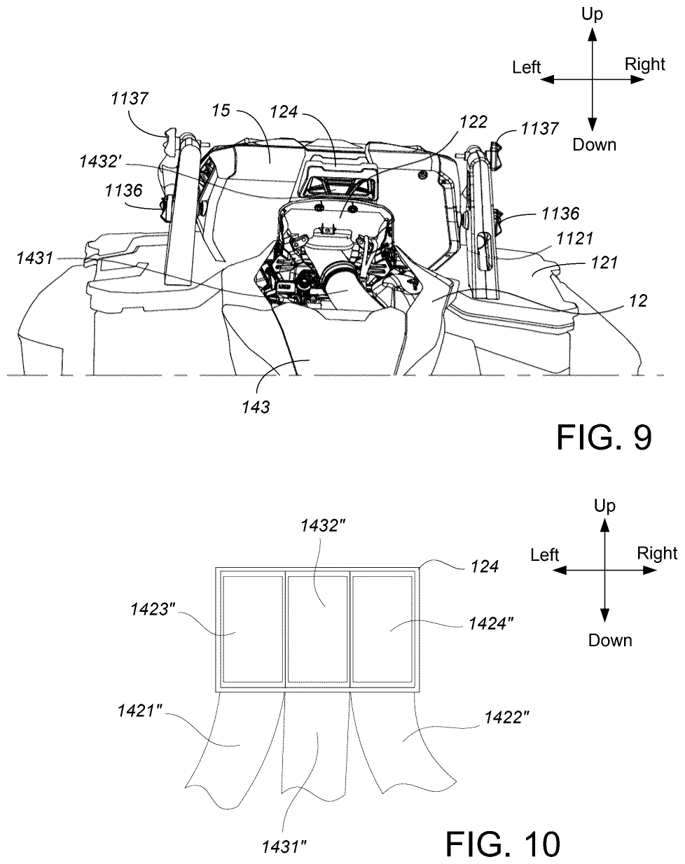

FIGS. 7-9 show an alternative embodiment in which only the combustion air inlet 1432′ is above the instrument panel 122 and above the main cover 123. The cooling air inlet 1423′ is underneath the main cover 123 facing downwardly and to the left. By facing downwardly like the cooling air outlet 1424, any mud and/or water that splashes up into the cooling air inlet 1423′ is more likely to gravitationally fall back out rather than flow into the CVT 142.

FIG. 10 schematically depicts a rear view of a third embodiment, in which all three of the cooling air inlet 1423″, the combustion air inlet 1432″ and the cooling air outlet 1424″ are arranged immediately adjacent each other left to right. This embodiment has the advantage that all three of the cooling air inlet 1423″, the combustion air inlet 1432″ and the cooling air outlet 1424″ can be defined in the single plastic part 124, which can be positioned above the instrument panel 122, with the cooling air intake duct 1421″, the air filter intake duct 1431″, and the cooling air outlet duct 1422″ all running vertically in front of the instrument panel 122 (so they do not interfere with the driver's sight lines to the instrument panel 122). Including the two inlets 1423″, 1432″ and cooling air outlet 1424″ on the same plastic part 124 simplifies the molding, inventorying and mounting operations associated for this air ducting, while improving the space utilization rate of the all-terrain vehicle 100. The downside of this single plastic part embodiment is that hot air from the cooling air outlet 1424″ can be recirculated into the cooling or combustion air inlets 1423″, 1432″.

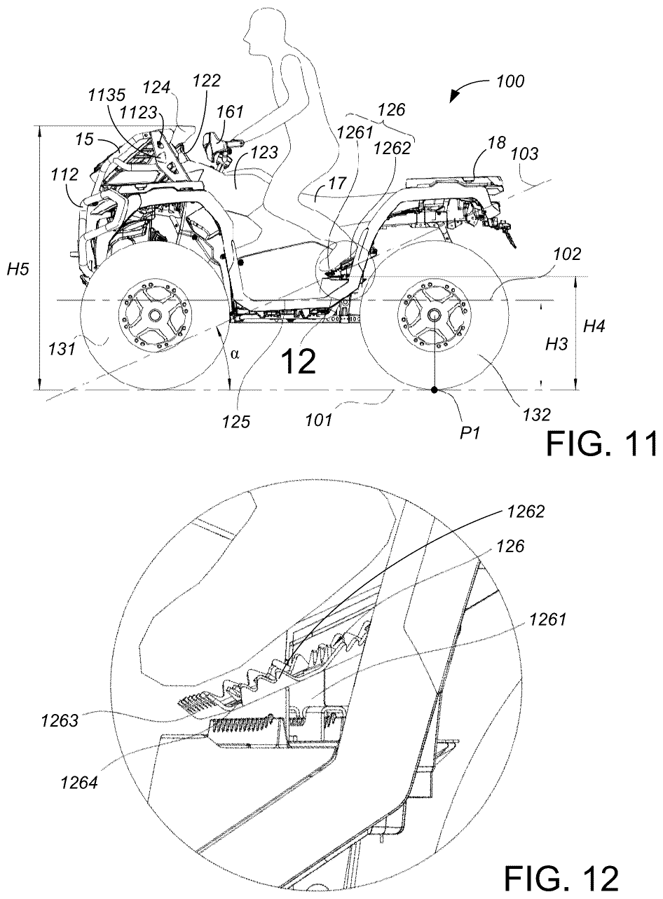

The vehicle cover 12 further includes two footrest plates 125 positioned on left and right sides of the engine 141 such as shown in FIGS. 1, 4 and 11. The footrest plates 125 support the driver's feet when driving in a normal riding posture, either sitting on the saddle 17 or standing on the footrest plates 125 and straddling the saddle 17. The normal riding posture is comfortable for most drivers for longer term driving. The footrest plates 125 define a footrest plane 102 called out in FIG. 11, which in the preferred embodiment is parallel to the ground plane 101. The footrest plates 125 have a footrest height H3 above the ground plane 101, defined at the lowest point of the footrest plates 125. The all-terrain vehicle 100 further includes two (left and right) foot hold assemblies 126 positioned behind and higher than the footrest plates 125, still lower than the saddle 17. The foot hold assemblies 126 are used to support the driver's feet when the driver is in an aggressive riding posture shown in FIGS. 11-13. The foot hold assemblies 126 have a foot hold height H4 above the ground plane 101, defined at the lowest point of the foot hold assemblies 126. The foot hold height H4 is preferably in the range from 54 cm to 72 cm, most preferably 60 cm. When the all-terrain vehicle 100 traverses deep mud and/or water conditions, the normal riding posture may cause the driver's feet to be submerged by the mud and/or water, resulting in a poor driving experience. In the aggressive riding posture, the driver raises his or her feet and steps rearwardly onto the foot hold assemblies 126, which can prevent the driver's feet from being submerged by the water and improve the driving experience. With the high foot hold height H4, most drivers will stand or crouch in the aggressive riding posture, resting less of their weight on the saddle 17 than is on the saddle 17 when sitting in the normal riding posture.

The foot hold assemblies 126 include a foot hold bracket 1261 and a foot hold traction plate 1262. The foot hold bracket 1261 is fixedly connected to the frame 11 and extends outwardly. The foot hold traction plate 1262 is positioned above and fixedly connected to the foot hold bracket 1261, defining a traction plate plane 103. The foot hold bracket 1261 preferably positions the foot hold traction plate 1262 such that the traction plate plane 103 is at a foot hold traction plate angle α relative to the ground plane 101 and/or relative to the footrest plane 102, angled forwardly and downwardly. The foot hold traction plate angle α is preferably in the range from 15 degrees to 40 degrees, more preferably in the range from 22 degrees to 33 degrees, and most preferably 27 degrees. When the all-terrain vehicle 100 climbs a slope, if the driver is in a normal riding posture, backward tiling of the driver's body caused by the slope can create a danger of flip-over. These preferred values for foot hold traction plate angle α help the driver to shift his or her weight forwardly in the aggressive riding posture, thereby reducing danger to the driver. In addition, these preferred values for foot hold traction plate angle α are in line with ergonomics, making the driver's stepping on to the foot hold traction plate 1262 more comfortable, thereby improving driving comfort.

The combustion air inlet 1432 is preferably positioned at or very close to the top of the all-terrain vehicle 100. A distance between the top of the combustion air inlet 1432 and the ground plane 101 is defined as a vehicle height H5 as called out in FIG. 11. A foot hold to overall height ratio H4/H5 of the foot hold height H4 to the vehicle height H5 is preferably in the range from 0.35 to 0.53. Foot hold to overall height ratios H4/H5 within this preferred range not only avoid the foot hold height H4 being too low and reducing the likelihood of the driver's feet being submerged by water when stepping on the foot hold assemblies 126, but also avoid the foot hold height H4 from being too high for the driver to conveniently step on the foot hold assemblies 126, thereby improving the human-machine interaction of the all-terrain vehicle 100.

As called out in FIG. 12, a plurality of anti-slip teeth 1263 are arranged on each of the left and right foot hold traction plates 1262. The anti-slip teeth 1263 protrude upwardly, and can contact the driver's shoe sole. The anti-slip teeth 1263 help minimize the likelihood of the driver's feet slipping off the foot hold traction plates 1262. Further, weight reduction holes 1264 are defined between adjacent anti-slip teeth 1263. The weight reduction holes 1264 not only reduce the weight of the foot hold traction plates 1262 and therefore the weight of the all-terrain vehicle 100, but also allow dirt or splashed onto the foot hold traction plates 1262 to be quickly discharged through the weight reduction holes 1264, thereby minimizing sediment accumulation on the foot hold traction plates 1262 keeping the foot hold traction plates 1262 from becoming slippery, enhancing driving safety.

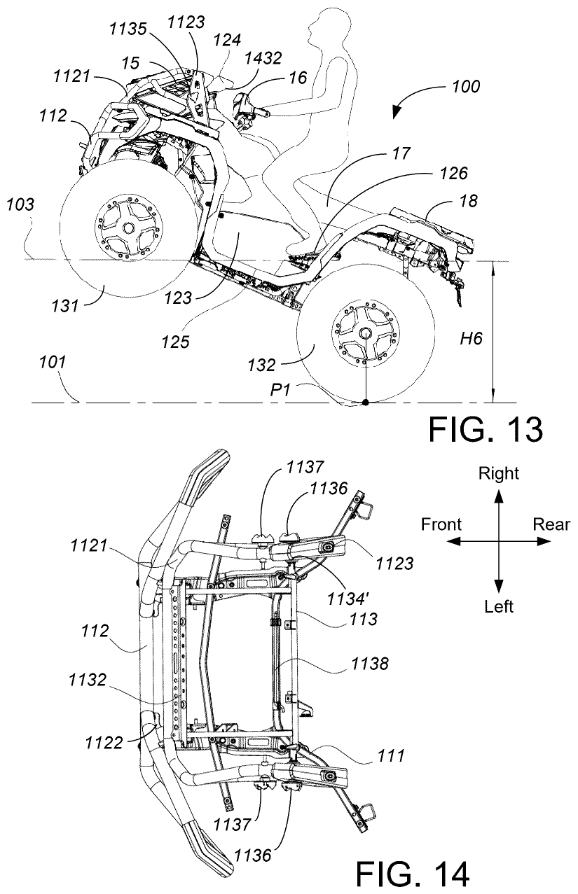

Some drivers will be able to maneuver the all-terrain vehicle 100 to a water wheelie balance point such as shown in FIG. 13. Skilled drivers will be able to drive the all-terrain vehicle at the water wheelie balance point across substantial lengths of bogs or other water or mud. The traction plate plane 103 is oriented such that when the all-terrain vehicle 100 is at the water wheelie balance point, the traction plate plane 103 is substantially horizontal. When the all-terrain vehicle 100 is at the water wheelie balance point, a foot-hold-during-wheelie height H6 can be defined between a low point P of the rear wheels 132 and the lowest point of the foot hold assemblies 126. The foot-hold-during-wheelie height H6 is greater than the foot hold height H4. The preferred foot-hold-during-wheelie height H6 is in the range from 67 cm to 83 cm, and most preferably 75 cm. Having a large value for foot-hold-during-wheelie height H6 allows skilled drivers to wade through deeper water while keeping their feet from being submerged, thereby improving the driver's driving experience. By increasing the water wading height of multiple components as described above, the water wading performance of the all-terrain vehicle is improved.

The frame 11 includes a main frame 111 and a protective front guard 112. The protective front guard 112 is fixedly connected to the main frame 111 toward the front of the main frame 111 and is mainly used to withstand impact loads. That is, in the event of a collision accident of the all-terrain vehicle 100, the protective front guard 112 absorbs the impact through its own deformation to reduce the impact load transmitted to the driver and avoid harm to the driver caused by the collision accident of the all-terrain vehicle 100. The protective front guard 112 preferably includes an upper bar 1121 at least partially positioned above the front cover plate 121 and fixedly connected to the main frame 111.

The frame 11 further includes a radiator bracket 113. The radiator bracket 113 is pivotally mounted, preferably at least partially on the upper bar 1121. A top view of the upper bar 1121 and the radiator bracket 113 in a fully closed or lowest position is shown in FIG. 14. The radiator 151 is fixedly mounted on the radiator bracket 113. The all-terrain vehicle 100 further includes an electrical assembly 21, which includes components such as a fuse box 211, an on-board diagnostics (OBD) port 212, and a vehicle controller 213 (such as an Electronic Control Unit or ECU) shown in FIGS. 15-17 and/or 19. In the preferred structure, the fuse box 211, the OBD port 212 and the vehicle controller 213 and are all connected to the main frame 111 at the front of the all-terrain vehicle 100, such that the fuse box 211, OBD port 212 and vehicle controller 212 are all beneath the radiator 151 at least when the radiator bracket 113 holds the radiator 151 in a fully closed or lowest position.

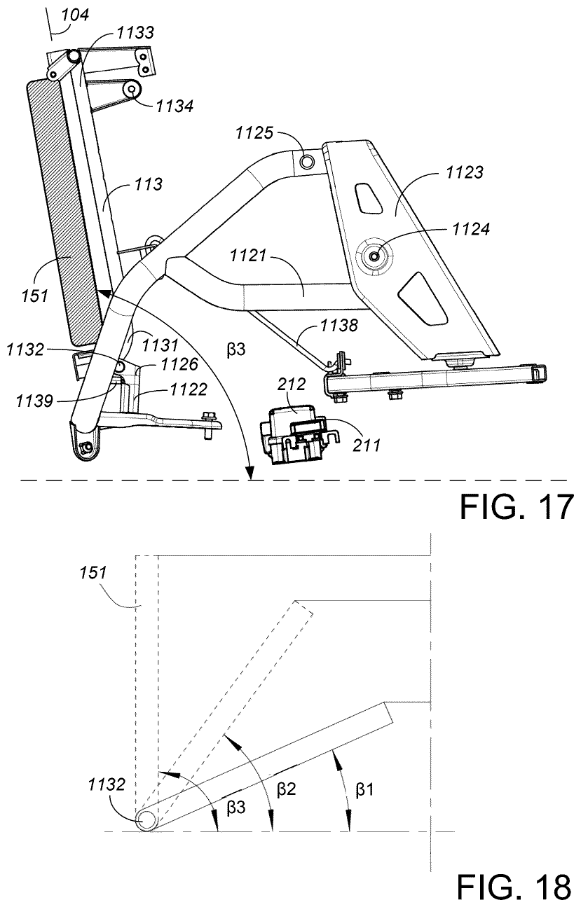

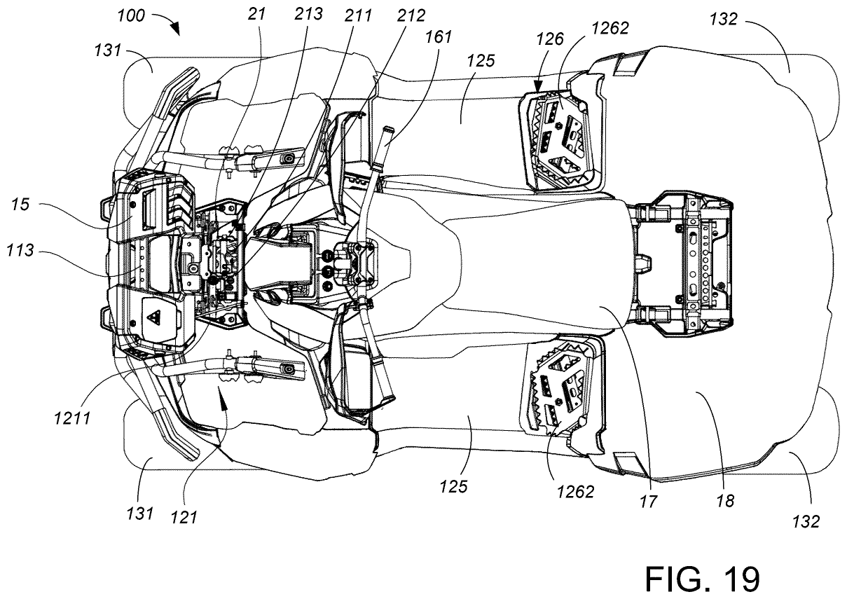

Side views of the upper bar 1121, the radiator bracket 113, the radiator 151, the fuse box 211 and the OBD port 212 are shown in FIGS. 15-17. Users can pivot the radiator bracket 113 between the positions shown in FIGS. 15, 16 and 17, and can secure or hold the radiator 151 in any of these three positions as depicted in the simplified view of FIG. 18. The position of the radiator 151 shown in FIG. 15 is the standard operating position of the radiator 151, and FIGS. 1-4, 11 and 13 show the all-terrain vehicle 100 with the radiator 151 also in this standard operating position. The position of the radiator 151 shown in FIG. 16 is considered a high-performance position. The position of the radiator 151 shown in FIG. 17 is considered a maintenance position. FIG. 19 shows a top plan view of the all-terrain vehicle while the radiator bracket 113 is in the maintenance position of FIG. 17.

The upper bar 1121 extends at least partially around the radiator bracket 113 including along left and right sides of the radiator bracket 113. The upper bar 1121 is mainly used to mount the radiator bracket 113 and provide protection for the radiator 151 while the radiator bracket 113 is pivoted downward in its standard operating position, avoiding damage to the radiator 151 in the event of a collision.

In the preferred embodiment, the lower, forward end 1131 of the radiator bracket 113 is pivotally connected to the upper bar 1121. Specifically, the radiator bracket 113 and the upper bar 1121 are connected by a pivot shaft 1132 positioned at the front, lower ends 1131 of the radiator bracket 113. The pivot shaft 1132 extends along the width direction of the all-terrain vehicle 100 and sequentially passes through front connection flanges 1122 of the upper bar 1121 and the front lower ends of the radiator bracket 113, so that the radiator bracket 113 can pivot relative to the upper bar 1121. The rear or upper end 1133 of the radiator bracket 113 is selectively positionable in any of a plurality of fixed positions relative to the upper bar 1121. In particular, the preferred protective front guard 112 includes two (left and right) rear attachment flanges 1123. A standard operating hole 1124 defining the standard operating position of the radiator bracket 113 is defined through each of the rear attachment flanges 1123. Two high performance holes 1125 defining the high performance position of the radiator bracket 113 are defined through the upper bar 1121.

Various structures can allow the user to position the radiator 151 in any of the standard operating position, the high performance position and the maintenance position, with several examples further discussed here. In one embodiment, threaded fixing holes 1134 are provided on left and right sides of the rear, upper end 1133 of the radiator bracket 113. A pair of hand knob screws 1135 are provided which can be threaded into the threaded fixing holes 1134 to fix the radiator bracket 113 relative to the upper bar 1121 and the all-terrain vehicle 100. When the user wants to change the position of the radiator 151 between the standard operating position and the high performance position, the user merely unscrews and pulls the hand knob screws 1135, repositions the radiator bracket 113 to the new position, and the tightens the hand knob screws 1135 through the other set of holes (1124 to 1125, or vice versa).

In another embodiment, four hand knob spring plungers are provided, two lower spring plungers 1136 attached on left and right sides of the rear attachment flanges 1123, and two upper spring plungers 1137 attached on left and right sides of the upper bar 1121. The radiator bracket 113 has left and right receiving holes 1134′, which do not need to be threaded. When the radiator bracket 113 is aligned in the standard operating position, two of the hand knob spring plungers (1136 or 1137) have pins that are spring biased into the receiving holes 1134′. When the user wants to change the position of the radiator 151 between the standard operating position and the high performance position, the user first pulls and twists those two lower hand knob spring plungers 1136 against the internal spring, out of the receiving holes 1134′. The user then pivots the radiator bracket 113 to the high performance position. Once the receiving holes 1134′ are aligned with the upper hand knob spring plungers 1137, the user twists the upper hand knob spring plungers 1137 until their pins spring release/advance into the receiving holes 1134′. The disadvantage of the embodiment using four hand knob spring plungers (1136 and 1137) is that four hand knob spring plungers (1136 and 1137) cost and weigh more than two hand knob screws 1135. The advantage of the embodiment using four hand knob spring plungers (1136 and 1137) is that the spring plungers (1136 and 1137) are permanently attached and cannot be lost or misplaced.

The preferred embodiment includes a significant lateral distance between the front connection flanges 1122, thereby making the pivoting of the radiator bracket 113 smoother and more stable. The preferred embodiment also includes a significant lateral distance between the left and right fixing holes (1134 or 1134′), thereby making the securing of the radiator bracket 113 in either the fully closed position or the partially open position more stable.

An access port 1211 is defined on the front cover plate 121, and the radiator assembly 15 covers above the access port 1211. In order to further facilitate maintenance or repair components of the electrical assembly 21, the radiator 151 can be pivoted to the maintenance position shown in FIGS. 17 and 19, allowing better access to the fuse box 211, to the OBD port 212, to the vehicle controller 213 and/or to other components of the electrical assembly 21 similarly positioned. Further, when the all-terrain vehicle 100 is driven over muddy or waterlogged roads, it is necessary to regularly inspect and/or clean the radiator 151 to avoid potential damage to the engine 141 due to excessive temperature caused by clogging of the radiator 151. Such inspection and/or cleaning of the radiator 151 is more easily achieved while the radiator 151 is in the maintenance position.

When the radiator 151 is in the maintenance position, the radiator 151 can be held by a movable support bar 1138. The movable support bar 1138 is similar to movable support bars used to hold hoods in raised positions on many automobiles, but can be in tension or in compression depending upon the balance point of the radiator 151. The radiator bracket 113 further includes a limit device 1139. The radiator bracket 113 can only be pivoted forwardly until the limit device 1139 contacts a stop 1126 on the upper bar 1121, thereby avoiding excessive rotation of the radiator bracket 113. When the limit device 1139 contacts the stop 1126, the radiator bracket 113 is in the maintenance position.

The radiator 151 defines a radiator plane 104 with a radiator angle β relative to horizontal. In the standard operating position, the radiator angle β1 is preferably in the range from 30° to 42°, most preferably 36°. In the high performance position, the radiator angle β2 is preferably in the range from 54° to 66°, most preferably 60°. The difference of the radiator angle value (β2−β1) between the standard operating and high performance positions is preferably in the range from 12° to 36°, most preferably 24°. The amount of headwind frontage (shown by the reference lines on FIG. 19) of the radiator 151 is proportional to sin(β), so the preferred high performance position is impacted by 21% to 83% and most preferably by about 47% more headwind than the preferred standard operating position (i.e., sin(β2)/sin(β1)), resulting in more cooling of the coolant flowing in the radiator assembly 15, particularly when driving at higher speeds. The high performance position of the radiator 151 is particularly beneficial when driving the all-terrain vehicle 100 at high speeds and/or in hot weather. Conversely, the standard operating position provides less drag for the all-terrain vehicle 100 and makes the front of the all-terrain vehicle 100 easier for the driver to see over. In the maintenance position, the radiator angle β3 is preferably in the range from 90° to 110°, most preferably 100°. Radiator angles β3 in this range for the maintenance position allow ready access to the components of the electrical assembly 21 such as the fuse box 211, OBD port 212 and ECU 213, while at the same time not overly changing the length required for coolant lines between the standard operating and maintenance positions.

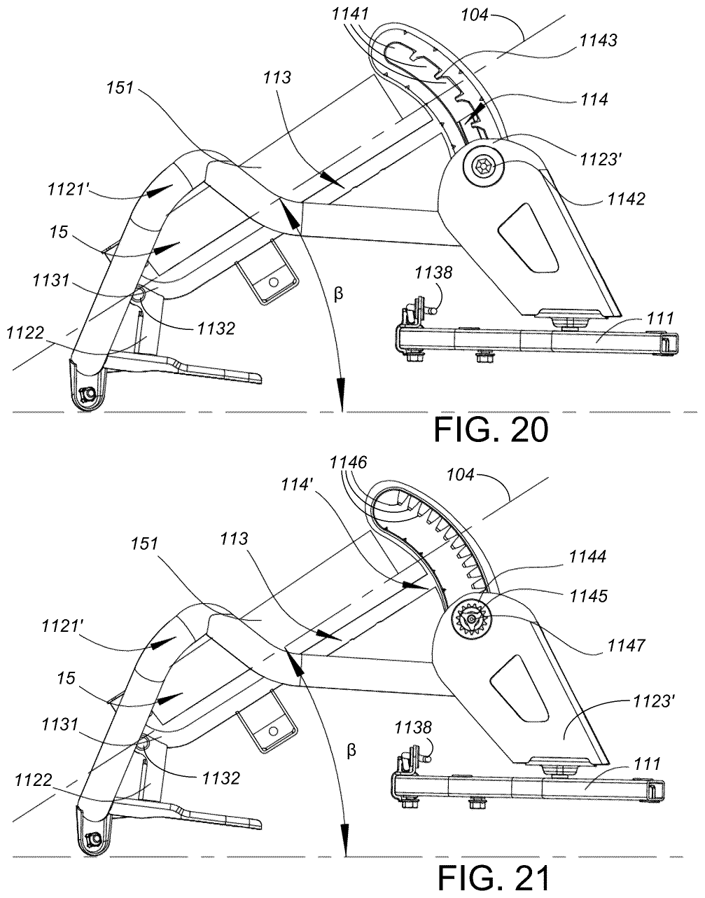

FIG. 20 shows an alternative embodiment where the left and right holes 1134 in the radiator bracket 113 are replaced with one or more angle setting flanges 114, preferably on both left and right sides of the radiator bracket 113. The angle setting flange 114 has a plurality of positions 1141 (in the embodiment shown, six different positions 1141 at about 5° increments) defined in a circular arc which can receive the pin end of a spring plunger 1142. The preferred angle setting flange 114 includes limiting teeth 1143 which define the plurality of the positions 1141 that can receive the pin end of the spring plunger 1142. To change the radiator angle β, the user pulls the spring plunger 1142 out of the angle setting flange 114, pivots the radiator bracket 113 to the desired new position, and releases the spring plunger 1142 so its pin end extends through the angle setting flange 114 to secure the radiator bracket 113. The driver can select which of the six radiator positions 1141 to use according to actual driving needs.

FIG. 21 shows another alternative embodiment in which the spring plunger 1142 is replaced with a hand-rotatable pinion 1144. The pinion 1144 has teeth 1145 which mesh with teeth 1146 on the angle setting flange 114′, such that the angle setting flange 114′ acts as a circular rack in a rack and pinion relationship. When the hand-rotatable pinion 1144 is rotated by the user, the meshing teeth 1145, 1146 cause the radiator bracket 113 to pivot. This embodiment allows the user to select the radiator angle β to any value within the range between the standard operating position and the high performance position, making for greater adjustment accuracy. The hand-rotatable pinion 1144 includes a toggle button 1147 having a secured position where the hand-rotatable pinion 1144 is fixed relative to the upper bar 1121 and a released position where the hand-rotatable pinion 1144 can rotate relative to the upper bar 1121.

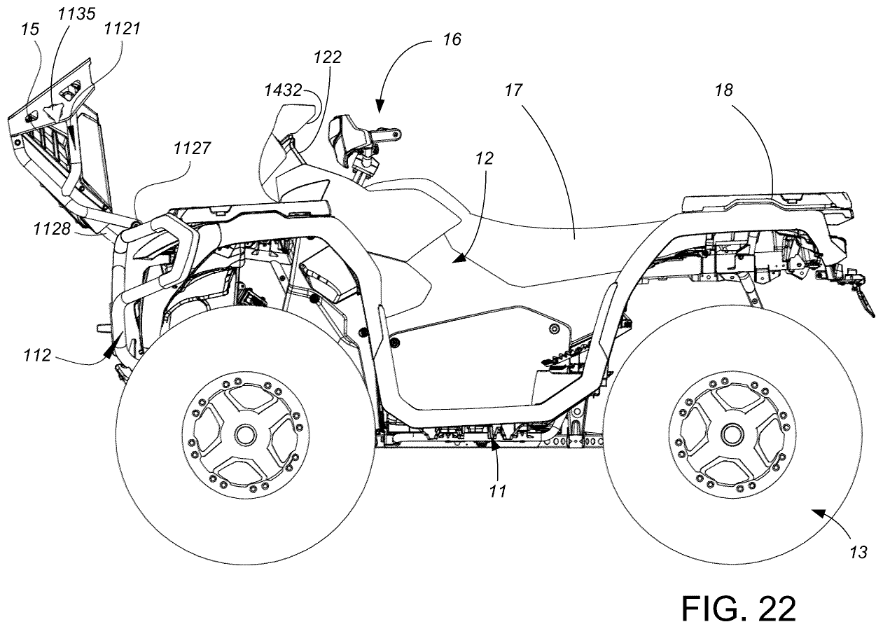

FIG. 22 depicts an alternative embodiment which can be combined with any of the prior embodiments. In FIG. 22, the upper bar 1121 is pivotally connected to the protective front guard 112 allowing pivoting about a transversely oriented pivot shaft 1127. To achieve the maintenance position of the radiator 151 and radiator bracket 113, the user need not release the knob screw 1135 or otherwise change the position of the radiator bracket 113 relative to the upper bar 1121, but instead can pivot the upper bar 1121 together with the radiator bracket 113 and radiator 151 upwardly and forwardly to the position shown in FIG. 22. A stop 1128 is arranged at the lower end of the upper bar 1121, which comes into contact with the protective front guard 112 once the pivoting reaches the desired maintenance position, to hold the upper bar 1121 and radiator assembly 15 in the position shown in FIG. 22.

After maintenance is completed on the radiator 151 or on the electrical components, the user can pivot the upper bar 1121 with the radiator assembly 15 back into the usage position. A latch (not shown) or similar structure can be used to fix the upper bar 1121 in the usage position. The knob screw 1135 and pivoting of the radiator bracket 113 relative to the upper bar 1121 is still available for the user to select either the high performance or the standard operating position of the radiator 151 after the upper bar 1121 has been pivoted back to the usage position. The position of the knob screw 1135 depicted in FIG. 22 signifies that the radiator 151 will be back in the standard operating position once the upper bar 1121 has been pivoted back to the usage position.

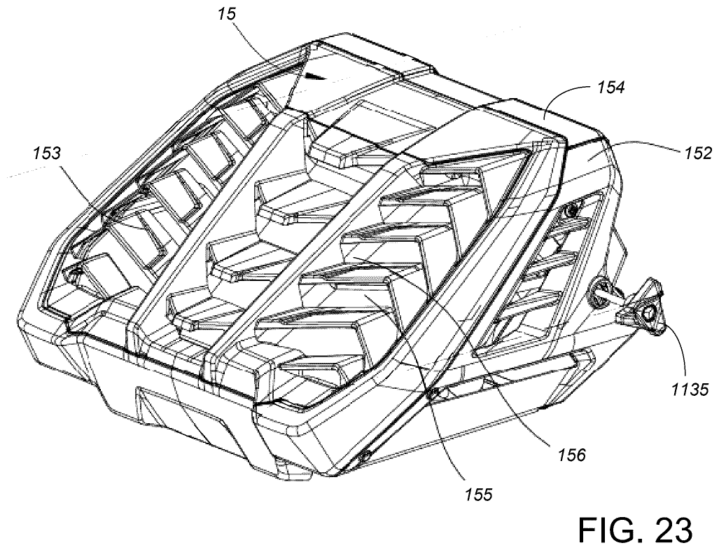

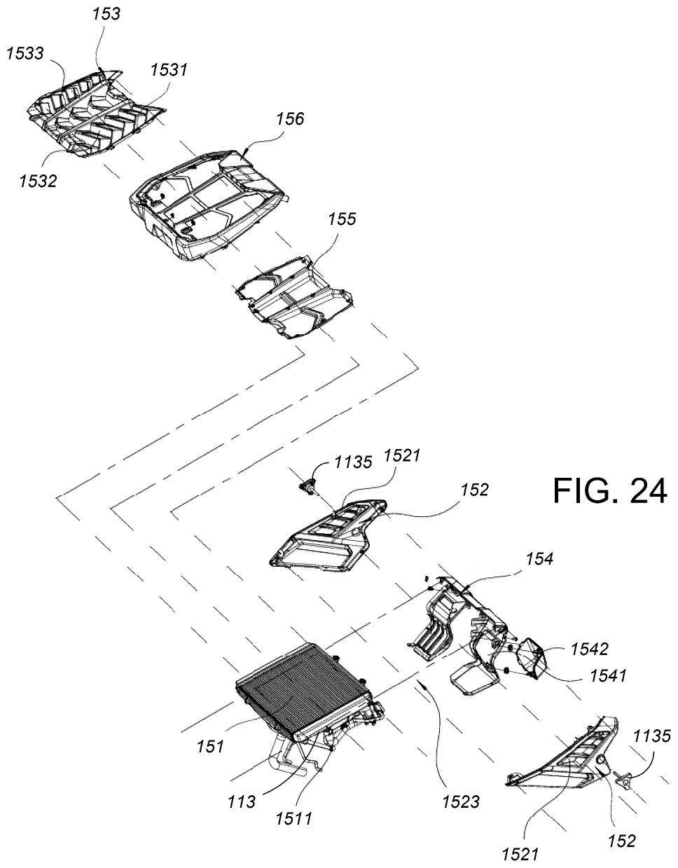

FIGS. 23 and 24 show perspective and exploded views of the preferred radiator assembly 15. The radiator assembly 15 includes left and right side radiator guards 152 around a front air intake grille 153 and a rear air exit grille 154. The front air intake grille 153 is positioned forward of the radiator 151, and the rear air exit grille 154 is positioned behind the radiator 151. Like the radiator 151 itself, the side radiator guards 152 and the front and rear grilles 153, 154 are fixedly connected to the radiator bracket 113, so pivoting of the radiator bracket 113 also pivots the side radiator guards 152 and the front and rear grilles 153, 154. The side radiator guards 152 and the grilles 153, 154 help protect the radiator 151 and prevent the radiator 151 from being damaged or clogged due to sand, gravel and mud splashing when the all-terrain vehicle 100 is driving, thereby improving the working environment of the radiator 151 and increasing its service life.

As shown in FIG. 24, the radiator assembly 15 preferably further includes a screen 155 and a screen support 156, both positioned upstream of the radiator 151. While the front air intake grille 153 prevents large debris (sticks, branches, leaves, etc.) from contacting and damaging the radiator 151, the screen 155 helps keep small debris out of and away from the radiator 151. The front air intake grille 153, the screen support 156 and the screen 155 preferably all snap in place so as to be removable without tools, allowing users to easily remove these parts 153, 155 and 156 for cleaning even while out on the trail. The left and right side radiator guards 152 are preferably both equipped with air holes 1521, further improving air flow to and from the radiator 151.

The preferred radiator 151 includes a filling pipe 1511 positioned on the side of the radiator 151 adjacent to the rear air grille 154. The filling pipe 1511 is used to fill the radiator 151 with coolant when necessary. An opening 1541 is defined through the rear air grille 154, and a readily removable fill cover 1542 is mounted to cover the opening 1541. When assembled, the opening 1541 overlaps the filling pipe 1511 longitudinally behind the filling pipe 1511. Removal of the fill cover 1542 makes it easy to directly fill the filling pipe 1511 with coolant without disassembling the rear air grille 154.

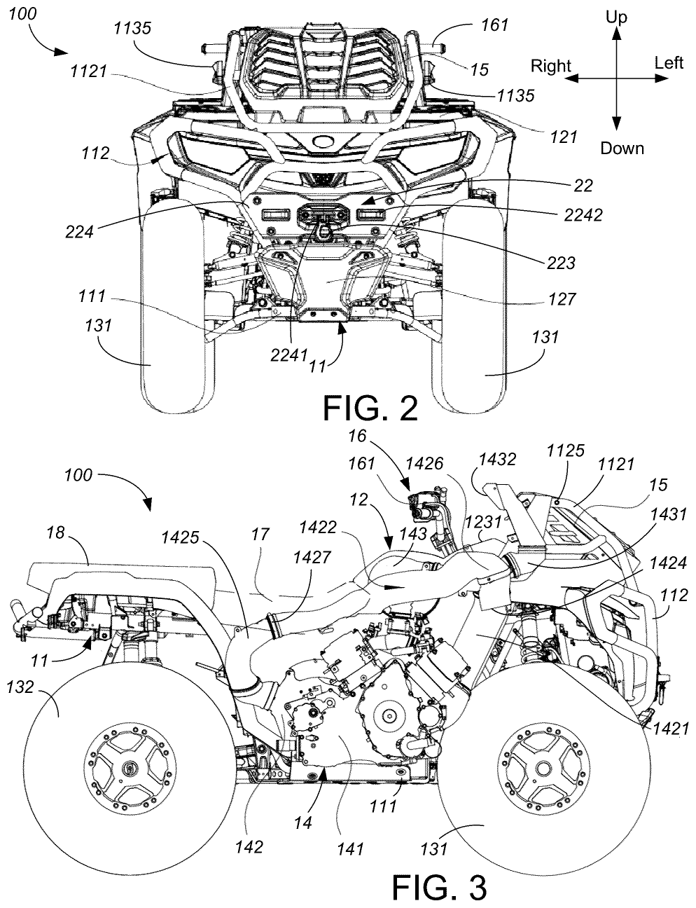

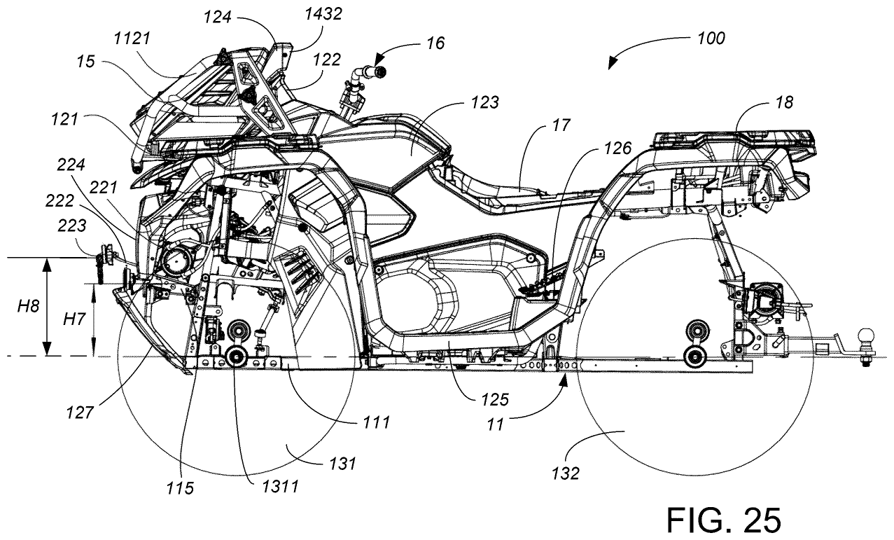

The preferred all-terrain vehicle 100 further includes a winch assembly 22, called out in FIG. 2 and further shown in FIG. 25. The winch assembly 22 includes a winch motor 221, a winch cable 222, a winch hook 223 and a winch mounting front plate 224. The winch assembly 22 is at least partially positioned at the lower front of the all-terrain vehicle 100 between the front wheels 131, but higher than a front skid plate 127 and higher than a front wheel axis of rotation 1311. The frame 11 further includes an adapter bracket 115 positioned forward of the main frame 111, and the winch assembly 22 is fixedly connected to the adapter bracket 115. The adapter bracket 115 is fixedly connected to the main frame 111 by means of welding or bolt connection, thereby avoiding damage to the frame 11 caused by the tension generated by the winch assembly 22 during operation. The winch mounting front plate 224 is fixedly connected to the protective front guard 112. The winch mounting front plate 224 defines an outlet 2241, and the winch cable 222 extends forward and passes through the outlet 2241. The width of the outlet 2241 is greater than the outer diameter of the winch cable 222 and less than the thickness of the winch hook 223, so that the outlet 2241 allows the winch cable 222 to pass through without allowing the winch hook 223 to pass through. The location for the winch assembly 22 exposes the winch hook 223 on the front of the vehicle 100, and places the winch assembly 22 at least partially under the radiator 151 and at least partially under the electrical assembly 21. The winch mounting front plate 224 also includes two drag hole tow points 2242 on opposing left and right sides of the outlet 2241, which are convenient locations for towing the vehicle 100 and/or attaching winch hooks of other all-terrain vehicles.

Specifically, the bottom of the winch assembly 22 is a winch assembly height H7 above the front wheel axis of rotation 1311, and the winch outlet 2241 is at a winch outlet height H8 above the front wheel axis of rotation 1311. The winch assembly height H7 is preferably in the range from 9 cm to 14 cm, more preferably in the range from 10 cm to 13 cm, and most preferably 11.6 cm. The winch outlet height H8 is preferably several centimeters higher than the winch assembly height H7. A value for winch height H7 which is too high can result in interference between the winch assembly 22 and the electrical assembly 21. If the winch 22 is used to help free the front of the all-terrain vehicle 100 from sinking into mud, then a low value for winch height H7 is desired so the winch 22 can more easily generate lifting force on the front of the all-terrain vehicle 100. At the same, a value for winch outlet height H8 which is too low can make it difficult to find and access the winch hook 223 as the front of the all-terrain vehicle 100 sinks into deep mud.

It should be understood that for those skilled in the art, improvements or transformations can be made based on the above description, and all such improvements and transformations should fall within the scope of protection of the claims attached to this application.

1. An all-terrain vehicle comprising:
a frame comprising a main frame and a protective front guard positioned at least partially forward of the main frame;
a vehicle cover comprising a front cover plate positioned at least partially above the main frame;
a plurality of wheels supporting the main frame;
a prime mover assembly supported by the main frame, and the prime mover assembly being coupled to at least some of the plurality of wheels for locomotion of the all-terrain vehicle;
a radiator assembly positioned at least partially above the front cover plate, the radiator assembly comprising a radiator for dissipating heat from the prime mover assembly; and
an electrical assembly supported by the main frame;
wherein the frame further comprises a radiator bracket pivotally supporting the radiator assembly, wherein the radiator bracket can be secured with the radiator in a standard operating position at least partially above at least some of the electrical assembly, such that the radiator bracket can be pivoted between the standard operating position and a maintenance position thereby moving the radiator to facilitate access to the at least some of the electrical assembly.

2. The all-terrain vehicle of claim 1, wherein the radiator bracket pivots about a transversely extending pivot axis, and wherein the radiator bracket is secured against rotating via one or more hand controlled fasteners.

3. The all-terrain vehicle of claim 2, wherein the one or more hand controlled fasteners are left and right hand knob screws which can be inserted each through a standard operating position hole to secure the radiator bracket with the radiator in the standard operating position or through a high performance position hole to secure the radiator bracket with the radiator in the high performance position, wherein the radiator defines a radiator plane which is at a radiator angle to horizontal, the radiator angle being higher when in the high performance position than when in the standard operating position.

4. The all-terrain vehicle of claim 3, wherein the radiator angle in the range from 90° to 110° when in the maintenance position.

5. The all-terrain vehicle of claim 4, wherein the radiator angle is in the range from 30° to 42° when in the standard operating position.

6. The all-terrain vehicle of claim 5, wherein the radiator angle is in the range from 54° to 66° when in the high performance position.

7. The all-terrain vehicle of claim 1, wherein the electrical assembly comprises a fuse box, an on-board diagnostics port and a vehicle controller, and wherein at least one of the fuse box, an on-board diagnostics port are beneath the radiator in the standard operating position but exposed when the radiator is in the maintenance position.

8. The all-terrain vehicle of claim 1, wherein the vehicle cover comprises:
left and right footrest plates supported by the main frame and defining a footrest plane; and
left and right foot hold assemblies supported by the main frame at an elevation above the left and right footrest plates, each of the foot hold assemblies having a traction plate defining a traction plate plane, wherein the traction plate plane is at a foot hold traction plate angle relative to the footrest plane in the range from 15° to 40°.

9. The all-terrain vehicle of claim 1, wherein the prime mover assembly comprises an engine and a continuously variable transmission, and wherein the plurality of wheels comprises front wheels that are steered via a steering handlebar, the prime mover assembly having a cooling air inlet to a cooling air intake duct, a cooling air outlet from a cooling air outlet duct, and a combustion air inlet to an air filter intake duct, wherein the cooling air inlet, the cooling air outlet and the combustion air inlet are all forward of the steering handlebar.

10. The all-terrain vehicle of claim 9, wherein the vehicle cover comprises a main cover covering the prime mover assembly, wherein the combustion air inlet is above the main cover and wherein the cooling air outlet is below the main cover.

11. An all-terrain vehicle comprising:
a frame comprising a main frame and a protective front guard positioned at least partially forward of the main frame;
a vehicle cover comprising a front cover plate positioned at least partially above the main frame;
a plurality of wheels supporting the main frame;
a prime mover assembly supported by the main frame, and the prime mover assembly being coupled to at least some of the plurality of wheels for locomotion of the all-terrain vehicle; and
a radiator assembly positioned at least partially above the front cover plate, the radiator assembly comprising a radiator for dissipating heat from the prime mover assembly; and
wherein the frame further comprises a radiator bracket supporting the radiator, wherein the radiator bracket can be secured with the radiator in a standard operating position or can be secured with the radiator in a high performance position, wherein the radiator defines a radiator plane which is at a radiator angle to horizontal, the radiator angle being from 12° to 36° higher when in the high performance position than when in the standard operating position.

12. The all-terrain vehicle of claim 11, wherein the radiator angle is in the range from 30° to 42° when in the standard operating position, and wherein the radiator angle is in the range from 54° to 66° when in the high performance position.

13. The all-terrain vehicle of claim 11, wherein the radiator bracket comprises at least one angle setting flange which is pivotable with the radiator bracket, the angle setting flange allowing the radiator bracket to be secured at at least one position between the standard operating position and the high performance position.

14. The all-terrain vehicle of claim 13, wherein the angle setting flange comprises an arc-shaped opening, with a hand controlled fastener extending through the arc-shaped opening to secure the radiator bracket.

15. The all-terrain vehicle of claim 14, wherein several teeth are defined in the angle setting flange extending into the arc-shaped opening.

16. The all-terrain vehicle of claim 15, wherein the hand controlled fastener is a hand-rotatable pinion with pinion teeth that mesh with the teeth of the angle setting flange in a rack-and-pinion relationship.

17. The all-terrain vehicle of claim 16, wherein the hand-rotatable pinion comprises a toggle button, the hand-rotatable pinion being rotatable based on a first setting of the toggle button and being non-rotatable based on a second setting of the toggle button.

18. An all-terrain vehicle comprising:
a frame comprising a main frame and a protective front guard positioned at least partially forward of the main frame;
a vehicle cover comprising a front cover plate positioned at least partially above the main frame;
a plurality of wheels supporting the main frame;
a prime mover assembly supported by the main frame, and the prime mover assembly being coupled to at least some of the plurality of wheels for locomotion of the all-terrain vehicle; and
a radiator assembly positioned at least partially above the front cover plate, the radiator assembly comprising a radiator for dissipating heat from the prime mover assembly;
wherein the protective front guard comprises an upper bar exposed above the front cover plate, the upper bar being pivotably attached relative to the main frame, wherein the upper bar can be secured relative to the main frame with the radiator in a standard operating position, and wherein the upper bar can be pivoted to move the radiator between the standard operating position and a maintenance position.

19. The all-terrain vehicle of claim 18, wherein the radiator defines a radiator plane which is at a radiator angle to horizontal, the radiator angle being in the range from 90° to 110° when the radiator is in the maintenance position.

20. The all-terrain vehicle of claim 19, wherein the radiator angle is in the range from 30° to 42° when the radiator is in the standard operating position.
